(19) United States
(12) Patent Application Publication
(10) Pub. No.: US 2016/0028628 A1
(43) Pub. Date: Jan. 28, 2016

(54) COMMUNICATION SYSTEM, CONTROL APPARATUS, ADDRESS ALLOCATION METHOD, AND PROGRAM

(71) Applicant: NEC CORPORATION, Minato-ku, Tokyo (JP)

(72) Inventors: Lei SUN, Tokyo (JP); Kazuya SUZUKI, Tokyo (JP); Hideyuki SHIMONISHI, Tokyo (JP); Kazushi SUGYOU, Tokyo (JP)

(73) Assignee: NEC CORPORATION, Tokyo (JP)

(21) Appl. No.: 14/775,577

(22) PCT Filed: Mar. 13, 2014
(86) PCT No.: PCT/JP2014/056732

§ 371 Date: Sep. 11, 2015

(30) Foreign Application Priority Data
Mar. 14, 2013 (JP) 2013-051860

(51) Int. Cl. H04L 12/56; H04L 5/00; H04L 29/12

(52) U.S. Cl. CPC H04L 45/741; H04L 61/2015; H04L 61/6022; H04L 5/0044

(57) ABSTRACT

A communication system includes an allocated address storage unit that stores an address allocated using host location information, and an address management unit that refers to the allocated address storage unit and uses the host location information to allocate an address to a host to which the address has not been allocated.

### DESCRIPTION OF RELATED APPLICATION

The present invention is based upon and claims the benefit of the priority of Japanese patent application No. 2013-051860 filed on Mar. 14, 2013, the disclosure of which is incorporated herein in its entirety by reference thereto.

### TECHNICAL FIELD

The present invention relates to a communication system, control apparatus, address allocation method, and program, and particularly to a communication system, control apparatus, address allocation method, and program that provide an address allocation service.

### BACKGROUND

A computer network using Internet protocols (including IPv4 and IPv6) is generally referred to as an IP network. In an IP network, a host apparatus is identified with an IP address (32-bit IPv4 address or 128-bit IPv6 address). As the number of IP addresses increases, DHCP (Dynamic Host Configuration Protocol) has been widely used in large-scale networks (refer to Non-Patent Literatures 1 and 2).

In the Hype-V architecture in Microsoft's Windows (registered trademark) server 2008 R2, Virtual Network Manager on each server running Hyper-V can be used to define different ranges of MAC (Media Access Control) addresses to help avoid duplicate MAC addresses (refer to Non-Patent Literature 3).

In the VMWare (registered trademark) Virtual Infrastructure, a MAC address separated from a virtual machine is used within a given server. VMWare guarantees the uniqueness of the MAC address within a cluster. In return, an administrator is able to use VirtualCenter of VMWare that guarantees the uniqueness of all MAC addresses between clusters (refer to Non-Patent Literature 4).

These facts indicate that neither Hyper-V nor VMWare Virtual Infrastructure supports a network that allows the same MAC address. Instead, it is possible to generate and use unique virtual MAC addresses in these architectures. Further, these architectures provide a data center network manager and administrator with a detection tool for addressing the same MAC address issue.

Patent Literature 1 discloses a DHCP information management system enabling immediate communication even when a user device is replaced in an IP network that configures user devices using DHCP or DHCP-PD (Prefix Delegation).

Further, Non-Patent Literatures 5 and 6 propose a technology called OpenFlow. An OpenFlow switch, defined in Non-Patent Literature 6, comprises a secure channel for communicating with an OpenFlow controller, and operates according to a flow table, an addition to or rewriting of which is suitably instructed by the OpenFlow controller. In the flow table, a set of matching rules (Match Fields) to be matched against a packet header, flow statistics (Counters), and Instructions defining the processing contents is defined for each flow (refer to “5.2 Flow Table” in Non-Patent Literature 6).

For instance, upon receiving a packet, the OpenFlow switch searches for an entry having a matching rule (refer to “5.3 Matching” in Non-Patent Literature 6) that matches the header information of the received packet in the flow table. When an entry matching the received packet is found as a result of the search, the OpenFlow switch updates the flow statistics (Counters) and performs the processing contents (packet transmission from a designated port, flooding, discard, etc.) written in the instruction field of the entry on the received packet. On the other hand, when no entry matching the received packet is found as a result of the search, the OpenFlow switch requests the OpenFlow controller to set an entry via the secure channel, transmitting a request (Packet-In message) for control information for processing the received packet. The OpenFlow switch receives a flow entry defining the processing contents, and updates the flow table. As described, the OpenFlow switch forwards a packet using an entry stored in the flow table as control information.

### CITATION LIST

### Patent Literature

[Patent Literature 1]

Japanese Patent Kokai Publication No. JP-P2004-241831A

### Non-Patent Literature

[Non-Patent Literature 1]

Dynamic Host Configuration Protocol, RFC 1541, October 1993

[Non-Patent Literature 2]

Dynamic Host Configuration Protocol for IPv6 (DHCPv6), RFC 3315

[Non-Patent Literature 3]

Microsoft, “Configuring Virtual Networks,” [online], [searched on Mar. 7, 2013], the Internet <URL: http://technet.microsoft.com/en-us/library/cc 816585%28WS.10%29.asp x>

[Non-Patent Literature 4]

VMWare, “Virtual Infrastructure: Server Configuration Guide,” [online], [searched on Mar. 7, 2013], the Internet <URL: http://www.vmware.com/pdf/server_config.pdf>

[Non-Patent Literature 5]

Nick McKeown, et. al. “OpenFlow: Enabling Innovation in Campus Networks,” [online], [searched on Feb. 18, 2013], the Internet <URL: http://www.openflow.org/documents/openflow-wp-latest.pdf>

[Non-Patent Literature 6]

“OpenFlow Switch Specification” Version 1.3.1 (Wire Protocol 0x04), [online], [searched on Feb. 18, 2013], the Internet <URL: http://www.opennetworking.org/images/stories/downloads/specification/openflow-spec-v1.3.1.pdf>

### SUMMARY

### Technical Problem

The following analysis is given by the present invention. The DHCP service described above uses a MAC address to identify a device and therefore does not allow duplicated MAC addresses. Further, the other virtual network architectures are merely able to guarantee the uniqueness of a virtual MAC address.

It is an object of the present invention to provide a communication system, control apparatus, address allocation method, and program that allow the duplication of MAC addresses, thereby contributing to facilitating the construction of large-scale networks.

### Solution to Problem

According to a first aspect of the present invention, there is provided a communication system comprising an allocated address storage unit that stores an address allocated using host location information, and an address management unit that refers to the allocated address storage unit and uses the host location information to allocate an address to a host to which the address has not been allocated.

According to a second aspect of the present invention, there is provided a control apparatus comprising an allocated address storage unit that stores an address allocated using host location information, and an address management unit that refers to the allocated address storage unit and uses the host location information to allocate an address to a host to which the address has not been allocated.

According to a third aspect of the present invention, there is provided an address allocation method comprising an address allocating step of allocating a unique address using host location information. The present method is tied to a particular machine, which is a computer that allocates an address in response to a request from a host.

According to a fourth aspect of the present invention, there is provided a program having a computer that comprises an allocated address storage unit that stores an address allocated using host location information execute a process of confirming whether or not the address has been allocated by referring to the allocated address storage unit in response to an address allocation request, and a process of allocating an address using the host location information to a host to which the address has not been allocated. Further, this program can be stored in a computer-readable (non-transient) storage medium. In other words, the present invention can be realized as a computer program product.

### Advantageous Effects of Invention

According to the present invention, it becomes possible to allow the duplication of MAC addresses and contribute to facilitating the construction of a large-scale network.

### BRIEF DESCRIPTION OF THE DRAWINGS

FIG. 1 is a drawing showing the configuration of an exemplary embodiment of the present invention.

FIG. 2 is a drawing showing the configuration of a control apparatus of a first exemplary embodiment of the present invention.

FIG. 3 is a drawing showing the structure of an entry held in an allocated address management DB of the control apparatus of the first exemplary embodiment of the present invention.

FIG. 4 is a flowchart showing the operation of the control apparatus of the first exemplary embodiment of the present invention.

FIG. 5 is a drawing showing the configuration of a control apparatus of a second exemplary embodiment of the present invention.

FIG. 6 is a drawing showing the structure of an entry held in an allocated address management DB of the control apparatus of the second exemplary embodiment of the present invention.

FIG. 7 is a flowchart showing the operation of the control apparatus of the second exemplary embodiment of the present invention.

### MODES FOR CARRYING OUT THE INVENTION

First, a summary of an exemplary embodiment will be given with reference to the drawings. Note that drawing reference signs in the summary are given to each element as an example solely to facilitate understanding for convenience, and are not intended to limit the present invention to the modes shown in the drawings.

The present invention provides a method for providing a DHCP service based on location information for a cloud network environment in an exemplary embodiment thereof. This DHCP service method based on location information can be suitably combined with the operation of the OpenFlow controller in an OpenFlow network.

In an OpenFlow network, when a virtual machine (referred to as “VM” hereinafter) instance sends a DHCP request message to a data plane, an OpenFlow controller receives a Packet-In message having the DHCP request message stored in the payload thereof from an OpenFlow switch.

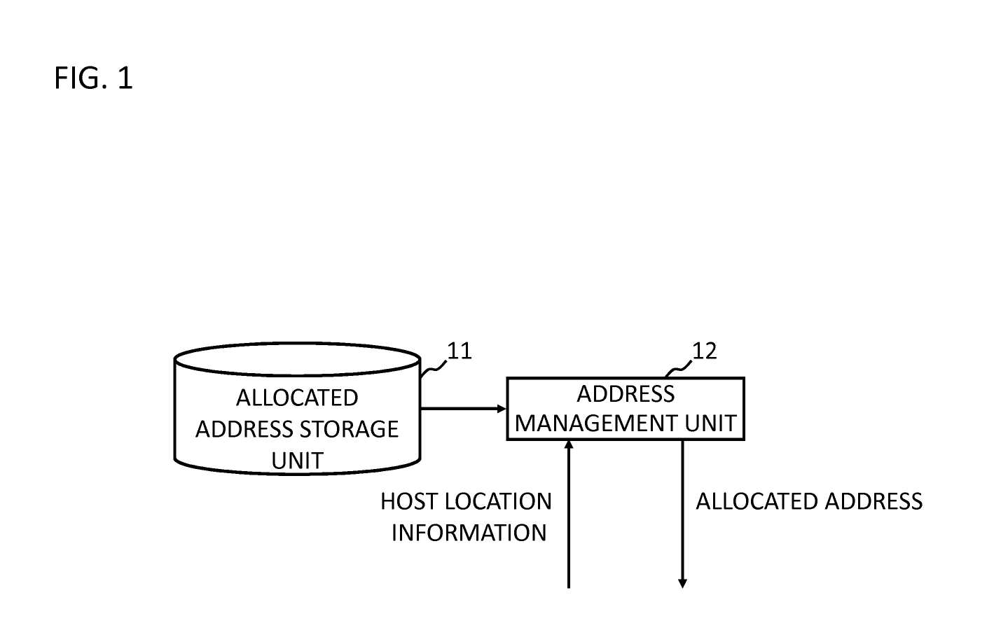

A communication system or control apparatus of the present exemplary embodiment can be realized by a configuration that includes an allocated address storage unit 11 and an address management unit 12 in an exemplary embodiment thereof, as shown in FIG. 1. For instance, the address management unit 12 extracts a set of a data path ID and a port number as location information from the Packet-In message. Then the address management unit 12 refers to the allocated address storage unit 11, and allocates an address based on the extracted location information to a client apparatus to which no address has been allocated.

As described, it becomes possible to provide a DHCP service based on location. Further, since this DHCP service does not utilize MAC addresses, the duplication of MAC addresses can be allowed.

Further, the present invention can be configured so that a control apparatus and a DHCP server operating independently in an internal network operate together in another exemplary embodiment thereof. In this exemplary embodiment, a 48-bit virtual MAC address is generated from the location information (for instance a 32-bit data path ID and a 2-bit port number) using a predetermined hash function.

### Exemplary Embodiment 1

Next, a first exemplary embodiment of the present invention will be described in detail with reference to the drawings. Note that many of the specific matters in the description below are given for illustrative purposes and for a better understanding of the present invention.

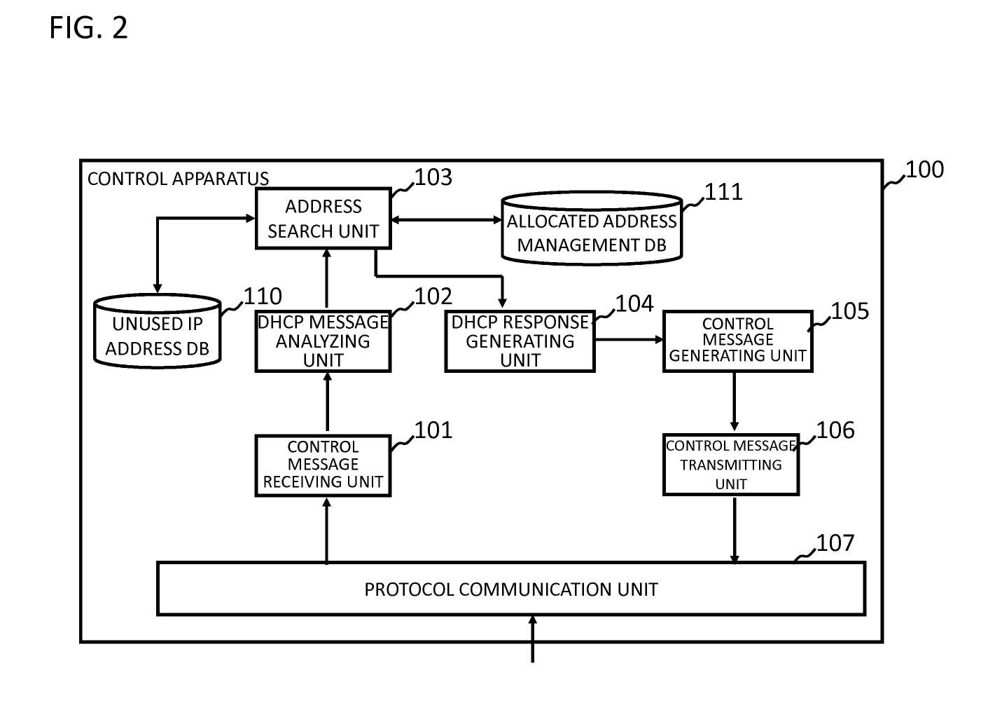

FIG. 2 is a block diagram illustrating the configuration of a control apparatus of the first exemplary embodiment of the present invention. In FIG. 2, the control apparatus 100 includes six function modules and two databases. Further, the control apparatus 100 functions as an OpenFlow controller that controls an OpenFlow switch (referred to as “switch” hereinafter) in Non-Patent Literature 6 and is able to receive a Packet-In message that notifies the reception of a packet without an entry having a corresponding matching rule from the switch.

More concretely, the control apparatus 100 of the present exemplary embodiment comprises a control message receiving unit 101 that receives the Packet-In message, a DHCP message analyzing unit 102, an address search unit 103 that performs an operation corresponding to that of the address management unit, a DHCP response generating unit 104, a control message generating unit 105, a control message transmitting unit 106, and a protocol communication unit 107.

Further, the control apparatus 100 of the present exemplary embodiment comprises an unused IP address DB (database) 110, and an allocated address management DB 111 (corresponding to the allocated address storage unit). Note that the unused IP address DB 110 may be configured as the ones used in a general DHCP service described in Background.

The DHCP message analyzing unit 102 analyzes a DHCP message sent by the control message receiving unit 101, extracts the ID (data path ID) and port number of the source switch, and sends them to the address search unit 103.

Upon receiving the ID (data path ID) and port number of the switch from the DHCP message analyzing unit 102, the address search unit 103 searches the allocated address management DB 111 to confirm whether or not an IP address has already been allocated to a corresponding host (a host connected to a port of the switch). If, as a result of the confirmation, it is confirmed that the corresponding host (a host connected to a port of the switch) has not been allocated any IP address, the address search unit 103 takes out an unallocated IP address from the unused IP address DB 110 and transmits a response instruction including the IP address to the DHCP response generating unit 104. Further, if the corresponding host (a host connected to a port of the switch) has been allocated an IP address, the address search unit 103 transmits a response instruction including the allocated IP address to the DHCP response generating unit 104.

Upon receiving the response instruction including an IP address from the address search unit 103, the DHCP response generating unit 104 generates a DHCP response packet and sends it to the control message generating unit 105.

Upon receiving the DHCP response packet from the DHCP response generating unit 104, the control message generating unit 105 generates a control message (Packet-Out message) for delivering the DHCP response packet to the host corresponding to the location information, and sends the control message to the control message transmitting unit 106. More concretely, the control message generating unit 105 generates a control message (Packet-Out message) that has the source switch that transmitted the Packet-In message output the DHCP response packet from the port that received a packet that triggered the transmission of the Packet-In message.

The control message transmitting unit 106 transmits the control message (Packet-Out message) generated by the control message generating unit 105 via the protocol communication unit 107.

The protocol communication unit 107 performs processing required for exchanging a control message with a switch connected via a control channel.

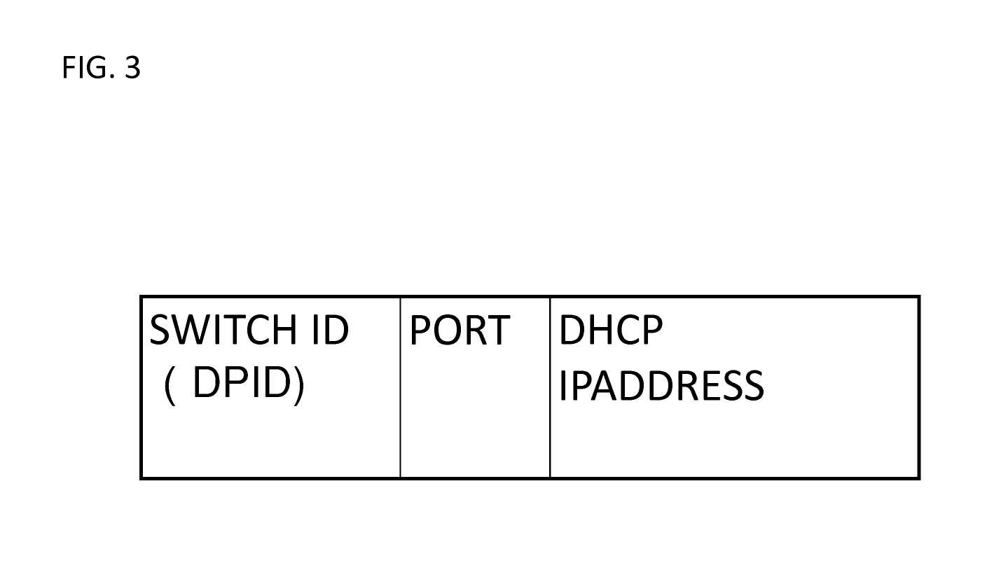

As shown in FIG. 3, the allocated address management DB 111 holds an entry that associates the data path ID, the ID of a switch, with at least the port number of the switch and an allocated DHCP IP address.

Further, the control apparatus 100 as described above can be configured by adding an address allocation function to an OpenFlow controller that receives a control message (Packet-In message) triggered by the reception of a DHCP request packet from a switch to be controlled.

Further, the function modules of the control apparatus 100 shown in FIG. 2 can be realized by a computer program having a computer that constitutes the control apparatus execute each processing described above using the hardware thereof.

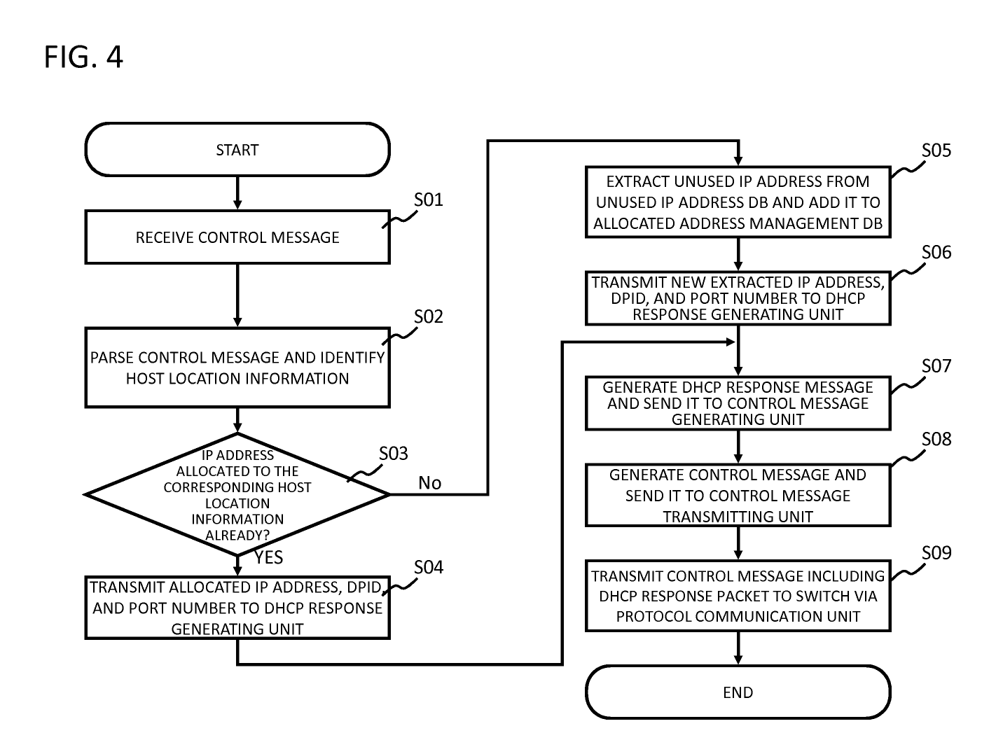

Next, the operation of the present exemplary embodiment will be described. FIG. 4 is a flowchart showing the operation of the control apparatus of the first exemplary embodiment of the present invention.

When a VM instance (host) connected to the OpenFlow switch generates a DHCP request message requesting an address, the switch that has received a packet including this message generates an OpenFlow Packet-In message and transmits the message to the control apparatus 100.

Upon receiving the Packet-In message (step S01 in FIG. 4), the control message receiving unit 101 of the control apparatus 100 extracts the DHCP message included in the payload of the Packet-In message and transmits the DHCP message to the DHCP message analyzing unit 102.

The DHCP message analyzing unit 102 parses the DHCP message, extracts a data path ID and port number, and outputs these to the address search unit 103 (step S02 in FIG. 4). By extracting the data path ID and the port number, the location of the VM instance (host) is identified.

The address search unit 103 searches for an entry corresponding to the data path ID and the port number in the allocated address management DB 111 (step S03 in FIG. 4).

(1) If a corresponding entry is found as a result of the search (YES in the step S03 in FIG. 4), it means that an IP address has been already allocated to this VM instance (host). In this case, the address search unit 103 outputs the contents of the entry including a DHCP IP address to the DHCP response generating unit 104 (step S04 in FIG. 4).

(2) On the other hand, if a corresponding entry is not found as a result of the search, the address search unit 103 extracts an unused IP address from the unused IP address DB 110. Then the address search unit 103 generates a new entry in which the data path ID and the port number are associated with the unused DHCP address and add the entry to the allocated address management DB 111 (step S05 in FIG. 4). Further, the address search unit 103 outputs the unused IP address extracted from the unused IP address DB 110, the data path ID, and the port number to the DHCP response generating unit 104 (step S06 in FIG. 4).

The DHCP response generating unit 104 generates a DHCP response message on the basis of the IP address received from the address search unit 103. Further, the DHCP response generating unit 104 outputs the DHCP response message with the data path ID and the port number received from the address search unit 103 to the control message generating unit 105 (step S07 in FIG. 4).

The control message generating unit 105 generates a control message (Packet-Out message) that instructs the DHCP response message to be outputted and sends the control message to the control message transmitting unit 106 (step S08 in FIG. 4). At this time, the control message generating unit 105 specifies a switch to which the control message (Packet-Out message) should be transmitted and a port of the switch that outputs the DHCP response message on the basis of the data path ID and the port number received from the DHCP response generating unit 104.

The control message transmitting unit 106 transmits the control message (Packet-Out message) according to the data path ID and the port number specified by the control message generating unit 105 (step S09 in FIG. 4).

As described, according to the present exemplary embodiment, it becomes possible to allocate an address without using any MAC address. Particularly, the present exemplary embodiment can be suitably applied to a cloud environment in which several virtual machine instances share the same MAC address using a system such as OpenFlow, and an address allocation method in this case can be provided.

### Exemplary Embodiment 2

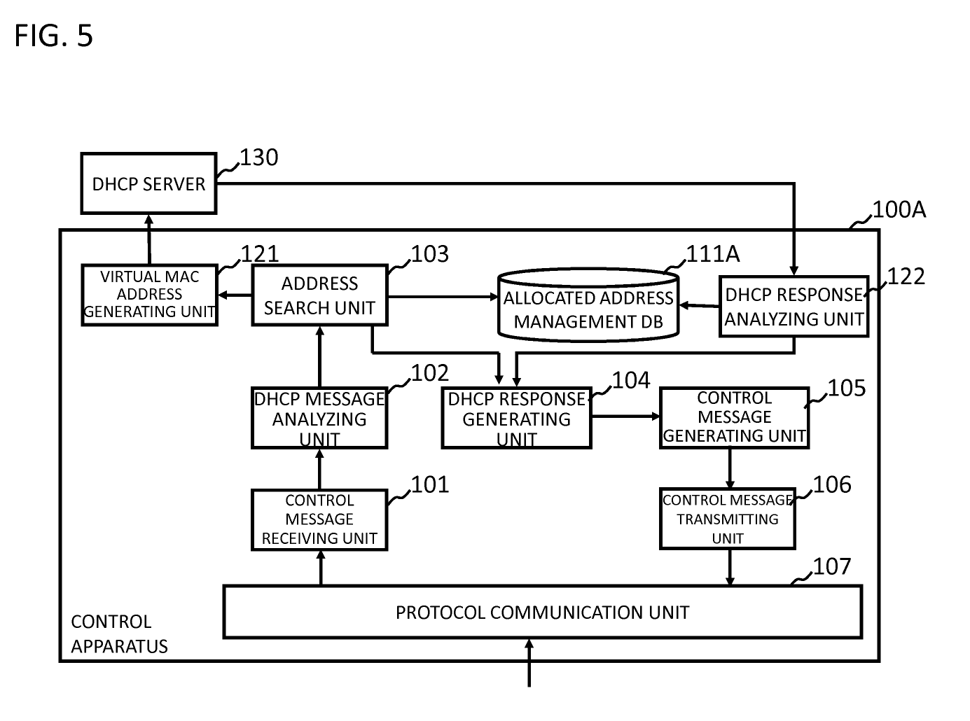

Next, a second exemplary embodiment in which a DHCP server is provided instead of the unused IP address DB 110 and the DHCP server and a control apparatus operate together will be described. FIG. 5 is a block diagram showing the configuration of the second exemplary embodiment of the present invention. FIG. 5 shows a configuration that includes a control apparatus 100A and a DHCP server 130.

In FIG. 5, the control apparatus 100A and the DHCP server 130 are connected via an internal network capable of forwarding DHCP messages such as a DHCP request message and DHCP response message.

The control apparatus 100A in FIG. 5 includes eight function modules and one database.

More concretely, the control apparatus 100A of the present exemplary embodiment comprises the control message receiving unit 101 that receives a Packet-In message from a switch, the DHCP message analyzing unit 102, the address search unit 103, the DHCP response generating unit 104, the control message generating unit 105, the control message transmitting unit 106, the protocol communication unit 107, a virtual MAC address generating unit 121, and a DHCP response analyzing unit 122. In other words, the virtual MAC address generating unit 121 and the DHCP response analyzing unit 122 are added to the configuration of the first exemplary embodiment. Differences from the first exemplary embodiment will be mainly described below.

The virtual MAC address generating unit 121 generates a virtual MAC address in response to a request from the address search unit 103 and transmits a DHCP request message to the DHCP server 130 using this virtual MAC address.

The DHCP response analyzing unit 122 analyzes a DHCP response message from DHCP server 130, which is a response to the DHCP request message, registers the response message in the allocated address management DB 111, and forwards the DHCP response message to the DHCP response generating unit 104.

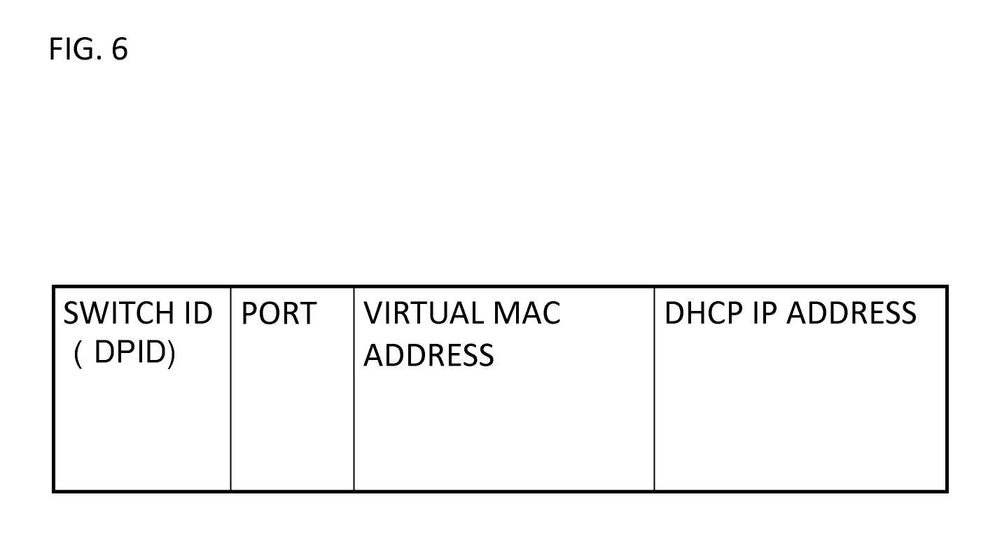

Further, as shown in FIG. 6, an allocated address management DB 111A of the control apparatus 100A of the present exemplary embodiment holds an entry in which a data path ID is associated with at least a port number, virtual MAC address, and issued DHCP address. In other words, a virtual MAC address field is added to the entry (refer to FIG. 3) held by the allocated address management DB 111 of the first exemplary embodiment.

Otherwise, the second exemplary embodiment is configured identically to the first exemplary embodiment; therefore, the explanation will be omitted.

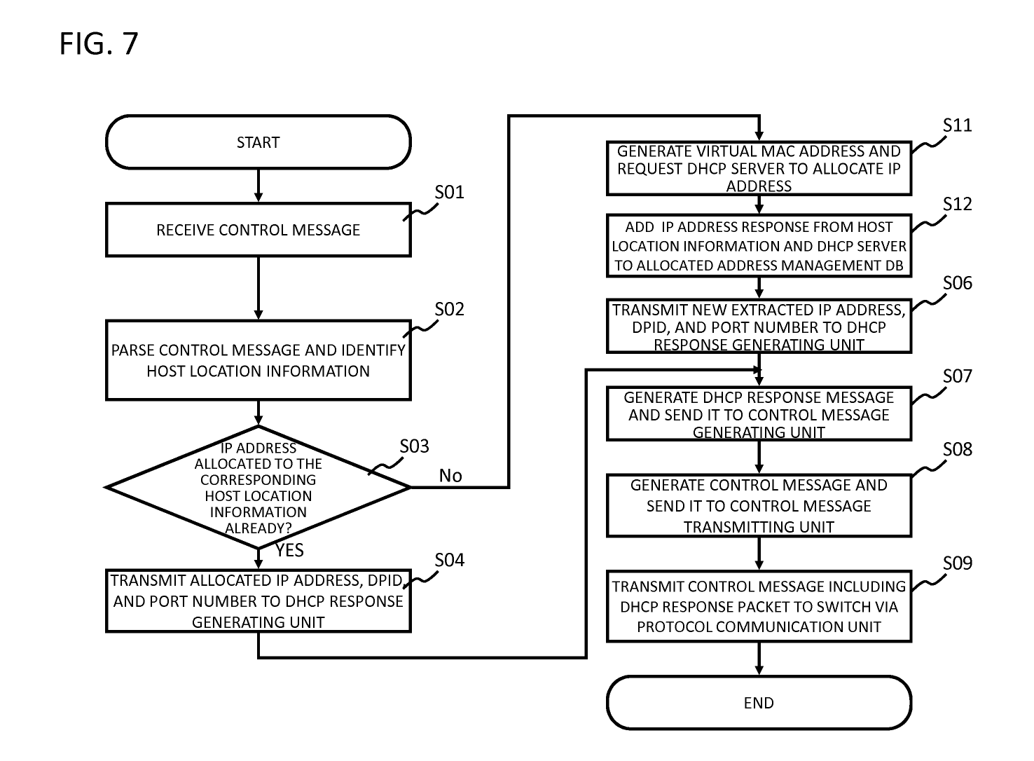

Next, the operation of the present exemplary embodiment will be described. FIG. 7 is a flowchart showing the operation of the control apparatus of the second exemplary embodiment of the present invention.

When a VM instance (host) connected to the OpenFlow switch generates a DHCP request message requesting an address, the switch that has received a packet including this message generates an OpenFlow Packet-In message and transmits the message to the control apparatus 100A.

Upon receiving the Packet-In message (step S01 in FIG. 7), the control message receiving unit 101 of the control apparatus 100A extracts the DHCP message included in the payload of the Packet-In message and transmits the DHCP message to the DHCP message analyzing unit 102.

The DHCP message analyzing unit 102 parses the DHCP message, extracts a data path ID and port number, and outputs these to the address search unit 103 (step S02 in FIG. 7).

The address search unit 103 searches for an entry corresponding to the data path ID and the port number in the allocated address management DB 111A (step S03 in FIG. 7).

(1) If a corresponding entry is found as a result of the search (YES in the step S03 in FIG. 7), it means that an IP address has been already allocated to the VM instance (host). In this case, the address search unit 103 outputs the contents of the entry including a DHCP IP address to the DHCP response generating unit 104 (step S04 in FIG. 7).

(2) On the other hand, if a corresponding entry is not found as a result of the search, the address search unit 103 transmits a set of the data path ID and the port number to the virtual MAC address generating unit 121 and request the generation of a virtual MAC address.

The virtual MAC address generating unit 121 generates a virtual MAC address from the set of the data path ID and the port number. The data path ID is a 32-bit unsigned integer, and the port number is a numerical value not greater than 256 that can be represented by an 8-bit unsigned integer. For instance, the virtual MAC address generating unit 121 generates a 48-bit virtual MAC address by padding the upper 8 bits of an 8-bit port number (with all 0s) thereby expanding it into a 16-bit port number.

Then the virtual MAC address generating unit 121 appends the generated virtual MAC address to the DHCP request message and transmits the result to the DHCP server 130 (step S11 in FIG. 7).

After the DHCP server 130 has returned a response to the DHCP request message, the DHCP response analyzing unit 122 analyzes the DHCP response packet, extracts a set of the data path ID, the port number, the virtual MAC address, and an unused IP address allocated by the DHCP server, and register these in the allocated address management DB 111 [111A?]. Further, the DHCP response analyzing unit 122 outputs the IP address received from the DHCP server 130 to the DHCP response generating unit 104 (step S06 in FIG. 7). Then the address search unit 103 transmits the data path ID and the port number identified in the step S02 to the DHCP response generating unit 104.

The DHCP response generating unit 104 generates a DHCP response message on the basis of the IP address received from the address search unit 103 or the DHCP response analyzing unit 122. Further, the DHCP response generating unit 104 outputs the DHCP response message with the data path ID and the port number received from the address search unit 103 to the control message generating unit 105 (step S07 in FIG. 7).

The control message generating unit 105 generates a control message (Packet-Out message) that instructs the DHCP response message to be outputted and sends the control message to the control message transmitting unit 106 (step S08 in FIG. 7). At this time, the control message generating unit 105 specifies a switch to which the control message (Packet-Out message) should be transmitted and a port of the switch to which the DHCP response message is outputted on the basis of the data path ID and the port number received from the DHCP response generating unit 104.

The control message transmitting unit 106 transmits the control message (Packet-Out message) according to the data path ID and the port number specified by the control message generating unit 105 (step S09 in FIG. 7).

As described, according to the configuration of the present exemplary embodiment in which a DHCP server (unused IP address DB) is not built in, it becomes possible to allocate an address without using a MAC address.

The exemplary embodiments of the present invention have been described, however, the present invention is not limited to these exemplary embodiments and further modifications, substitutions, and adjustments can be performed within the scope of the basic technological concept of the present invention. For instance, the control apparatuses described in the first and second exemplary embodiments can be realized with a plurality of apparatuses having the function modules and the databases shown in FIGS. 2 and 5.

Further, the method for generating a virtual MAC address in the exemplary embodiment above is merely a simple example, and other methods for creating a virtual MAC address can be employed.

Further, the exemplary embodiments above describe a sequence of operations triggered by the reception of a DHCP request message from a VM instance (host) in an assumed environment that allows the duplication of MAC addresses, however, it goes without saying that the transmission source of the DHCP request message is not limited to a VM instance (host). The present invention can be applied to an environment that does not allow the duplication of MAC addresses, and the same operation may be performed when a DHCP request message is received from other devices such as a user terminal or server.

Finally, preferred modes of the present invention will be summarized.

### [Mode 1]

(Refer to the communication system according to the first aspect.)

### [Mode 2]

In the communication system of Mode 1, the host location information is information that indicates a set of an identifier and port information of a switch connected to the host.

### [Mode 3]

The communication system of Mode 2 further comprising a packet analyzing unit that extracts the host location information from a packet reception notification from the switch.

### [Mode 4]

The communication system of any one of Modes 1 to 3 allocating an address obtained as a result of searching for an address that corresponds to the location information in the allocated address storage unit when an address allocation request is received and such an address exists.

### [Mode 5]

In the communication system of any one of Modes 1 to 4, the address management unit further comprises a function of registering a set of the location information and the allocated address in the allocated address storage unit.

### [Mode 6]

The communication system of any one of Modes 1 to 5 further comprising an unused address storage unit that manages an unused address, wherein

the address management unit extracts an unused address from the unused address storage unit and uses the unused address.

### [Mode 7]

The communication system of any one of Modes 1 to 5 further comprising a virtual MAC address generating unit that generates a virtual MAC address using the host location information and requests an external DHCP server to allocate an unused IP address.

### [Mode 8]

(Refer to the control apparatus according to the second aspect.)

### [Mode 9]

(Refer to the address allocation method according to the third aspect.)

### [Mode 10]

(Refer to the program according to the fourth aspect.)

Further, Modes 8 to 10 can be developed into Modes 2 to 7 as Mode 1.

Further, the disclosure of each Patent Literature and Non-Patent Literature cited above is incorporated herein in its entirety by reference thereto. It should be noted that other objects, features and aspects of the present invention will become apparent in the entire disclosure and that modifications may be done without departing the gist and scope of the present invention as disclosed herein and claimed as appended herewith. Also it should be noted that any combination of the disclosed and/or claimed elements, matters and/or items may fall under the modifications.

### REFERENCE SIGNS LIST

11: allocated address storage unit

12: address management unit

100, 100A: control apparatus

101: control message receiving unit

102: DHCP message analyzing unit

103: address search unit

104: DHCP response generating unit

105: control message generating unit

106: control message transmitting unit

107: protocol communication unit

110: unused IP address database (DB)

111, 111A: allocated address management database (DB)

121: virtual MAC address generating unit

122: DHCP response analyzing unit

130: DHCP server

What is claimed is:

1. A communication system comprising:
an allocated address storage unit that stores an address allocated using host location information; and
an address management unit that refers to the allocated address storage unit and uses the host location information to allocate an address to a host to which the address has not been allocated.

2. The communication system according to claim 1, wherein the host location information comprises information that indicates a set of an identifier and port information of a switch connected to the host.

3. The communication system according to claim 2, further comprising a packet analyzing unit that extracts the host location information from a packet reception notification from the switch.

4. The communication system according to claim 1, allocating an address obtained as a result of searching for an address that corresponds to the location information in the allocated address storage unit when an address allocation request is received and such an address exists.

5. The communication system according to claim 1, wherein the address management unit further comprises a function of registering a set of the location information and the allocated address in the allocated address storage unit.

6. The communication system according to claim 1, further comprising an unused address storage unit that manages an unused address, wherein
the address management unit extracts an unused address from the unused address storage unit and uses the unused address.

7. The communication system according to claim 1, further comprising a virtual MAC address generating unit that generates a virtual MAC address using the host location information and requests an external DHCP server to allocate an unused IP address.

8. A control apparatus comprising:
an allocated address storage unit that stores an address allocated using host location information; and
an address management unit that refers to the allocated address storage unit and uses the host location information to allocate an address to a host to which the address has not been allocated.

9. The control apparatus according to claim 8, wherein the host location information comprises information that indicates a set of an identifier and port information of a switch connected to the host.

10. The control apparatus according to claim 9, further comprising a packet analyzing unit that extracts the host location information from a packet reception notification from the switch.

11. The control apparatus according to claim 8, allocating an address obtained as a result of searching for an address that corresponds to the location information in the allocated address storage unit when an address allocation request is received and such an address exists.

12. The control apparatus according to claim 8, wherein the address management unit further comprises a function of registering a set of the location information and the allocated address in the allocated address storage unit.

13. The control apparatus according to claim 8, further comprising an unused address storage unit that manages an unused address, wherein
the address management unit extracts an unused address from the unused address storage unit and uses the unused address.

14. The control apparatus according to claim 8, further comprising a virtual MAC address generating unit that generates a virtual MAC address using the host location information and requests an external DHCP server to allocate an unused IP address.

15. An address allocation method, comprising:
acquiring host location information: and allocating a unique address using the host location information.

16. The address allocation method according to claim 15, wherein the host location information comprises information that indicates a set of an identifier and port information of a switch connected to the host.

17. The address allocation method according to claim 16, further comprising extracting the host location information from a packet reception notification from the switch.

18. The address allocation method according to claim 15, further comprising allocating an address obtained as a result of searching for an address that corresponds to location information in an allocated address storage unit that stores an address allocated using the host location information.

19. The address allocation method according to claim 15, further including registering a set of the location information and the allocated address in the allocated address database.

20. The address allocation method according to claim 15, wherein an address allocated to the host comprises an address extracted from an unused address database that manages an unused address.

21. The address allocation method according to claim 15, further including generating a virtual MAC address using the host location information and requesting an external DHCP server to allocate an unused IP address.

22. A non-transitory computer-readable recording medium storing thereon a program having a computer that comprises an allocated address storage unit that stores an address allocated using host location information execute:
a process of confirming whether or not the address has been allocated by referring to the allocated address storage unit in response to an address allocation request; and
a process of allocating an address using the host location information to a host to which the address has not been allocated.
